(19) United States
(12) Patent Application Publication
(10) Pub. No.: US 2023/0210118 A1
(43) Pub. Date: Jul. 6, 2023

(54) DOUGH PROOFING COMPARTMENT IN A REFRIGERATOR APPLIANCE

(71) Applicant: Haier US Appliance Solutions, Inc., Wilmington, DE (US)

(72) Inventors: Sabrina Marie Hannah, Louisville, KY (US); James Lee Armstrong, Louisville, KY (US); Kyle Andrew Kozinski, Louisville, KY (US)

(21) Appl. No.: 17/582,423

(22) Filed: Jan. 24, 2022

Related U.S. Application Data
(63) Continuation of application No. 17/569,833, filed on Jan. 6, 2022, now abandoned.

(51) Int. Cl. A21C 13/00; F25D 11/02; F25D 29/00

(52) U.S. Cl. CPC A21C 13/00; F25D 11/02; F25D 29/00

(57) ABSTRACT

A refrigerator appliance is provided including a cabinet defining a chilled chamber and a climate control assembly for regulating a chamber temperature within the chilled chamber. A controller receives a command to perform a dough proofing cycle and a dough removal time, determines a temperature schedule to facilitate the dough proofing cycle, the temperature schedule ending at the dough removal time, and operates the climate control assembly to regulate a chamber temperature of the chilled chamber in accordance with the temperature schedule.

### PRIORITY STATEMENT

This application claims the benefit of priority to U.S. patent application Ser. No. 17/569,833, filed on Jan. 6, 2022, the disclosure of which is incorporated by reference herein in the entirety.

### FIELD OF THE INVENTION

The present subject matter relates generally to refrigerator appliances, and more particularly a system and method for proofing dough in a refrigerator appliance.

### BACKGROUND OF THE INVENTION

Refrigerator appliances generally include a cabinet that defines a chilled chamber for receipt of food articles for storage. In addition, refrigerator appliances include one or more doors rotatably hinged to the cabinet to permit selective access to food items stored in chilled chamber(s). The refrigerator appliances can also include various storage components mounted within the chilled chamber and designed to facilitate storage of food items therein. Such storage components can include racks, bins, shelves, or drawers that receive food items and assist with organizing and arranging of such food items within the chilled chamber.

Refrigerator appliances may periodically be used to ferment dough, e.g., for use in making bread, pastries, or other yeasted baked goods. During fermentation, sugar is converted into alcohol and carbon dioxide resulting in changes to dough composition, flavor, texture and shape. Controlling the fermentation process has a substantial impact on the quality of the completed baked good. Manipulating primary fermentation conditions can be desirable to produce specific flavor profiles. Secondary fermentation (often referred to as proofing) is necessary to allow the dough to have the proper shape (rise) before baking. Manipulating secondary fermentation conditions can help ensure proper baking quality and allow the baker to adjust the time that the finished goods will be ready.

In general, the time required to ferment/proof dough depends in part on the dough temperature. For example, at 40° F. a yeast dough may not rise at all, while dough maintained at 70° F. may rise in approximately 2 hours. By placing dough in a refrigerator, the proofing process may be slowed down or stopped altogether. However, the bread maker must remember to take the dough out of the refrigerator at a specific time prior to commencing the baking process and move it to another location with a different storage temperature. Failure to do so could result in under- or over proofing the dough. For example, a baker who desired fresh baked cinnamon rolls in the morning commonly prepares the rolls the night before to avoid having to get up very early. Placing the dough in the refrigerator overnight may prevent the dough from over-proofing and allows the food to be kept safely overnight. However, to achieve the best quality, the dough should be allowed to proof at room temperature for 1-3 hours before baking, thus requiring the baker to get up early and remove the dough well before baking.

Accordingly, a refrigerator appliance with systems for facilitating dough proofing would be useful. More particularly, a refrigerator appliance that facilitates an improved dough proofing process with minimal intervention by the bread maker would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, a refrigerator appliance is provided including a cabinet defining a chilled chamber, a door being movable between an open position and a closed position to provide selective access to the chilled chamber, a climate control assembly for regulating a chamber temperature within the chilled chamber, and a controller operably coupled to the climate control assembly. The controller is configured to receive a command to perform a dough proofing cycle and a dough removal time, determine a temperature schedule to facilitate the dough proofing cycle, the temperature schedule ending at the dough removal time, and operate the climate control assembly to regulate a chamber temperature of the chilled chamber in accordance with the temperature schedule.

In another exemplary embodiment, a method of proofing dough in a refrigerator appliance is provided. The refrigerator appliance includes a chilled chamber and a climate control assembly for regulating a chamber temperature within the chilled chamber. The method includes receiving a command to perform a dough proofing cycle and a dough removal time, determining a temperature schedule to facilitate the dough proofing cycle, the temperature schedule ending at the dough removal time, and operating the climate control assembly to regulate a chamber temperature of the chilled chamber in accordance with the temperature schedule.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a refrigerator appliance according to an exemplary embodiment of the present subject matter.

FIG. 2 provides a front view of the exemplary refrigerator appliance of FIG. 1, with the doors of the fresh food chamber shown in an open position according to an exemplary embodiment of the present subject matter.

FIG. 3 provides a perspective view of the exemplary refrigerator appliance of FIG. 1, with a proofing compartment drawer shown in an open position according to an exemplary embodiment of the present subject matter.

FIG. 4 is schematic view of a climate control assembly of the exemplary refrigerator appliance of FIG. 1 according to an exemplary embodiment of the present subject matter.

FIG. 5 provides a method of proofing dough in a refrigerator appliance according to an exemplary embodiment of the present subject matter.

FIG. 6 provides a plot of an exemplary temperature schedule for facilitating a proofing process according to an exemplary embodiment of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “upstream” and “downstream” refer to the relative flow direction with respect to fluid flow in a fluid pathway. For example, “upstream” refers to the flow direction from which the fluid flows, and “downstream” refers to the flow direction to which the fluid flows. The terms “includes” and “including” are intended to be inclusive in a manner similar to the term “comprising.” Similarly, the term “or” is generally intended to be inclusive (i.e., “A or B” is intended to mean “A or B or both”).

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a 10 percent margin.

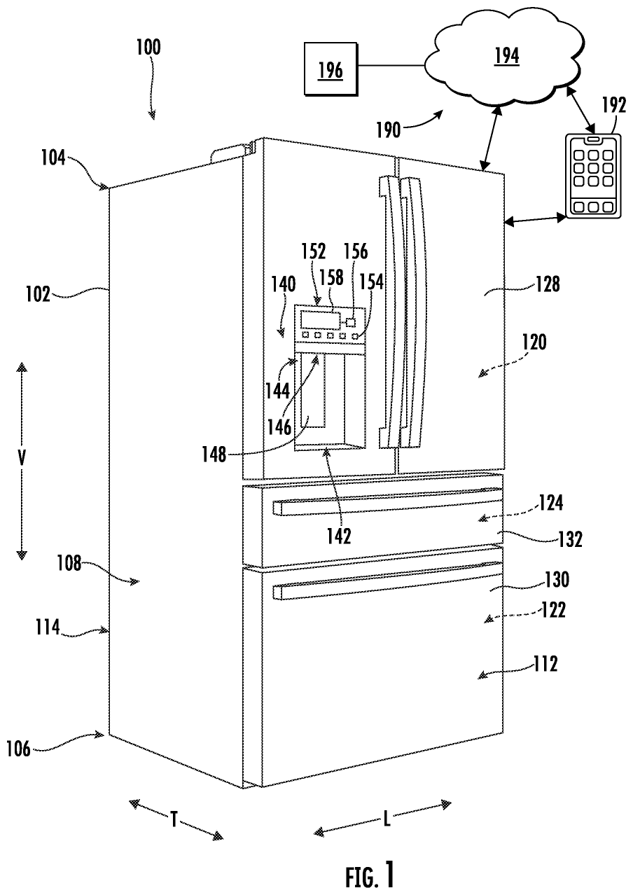

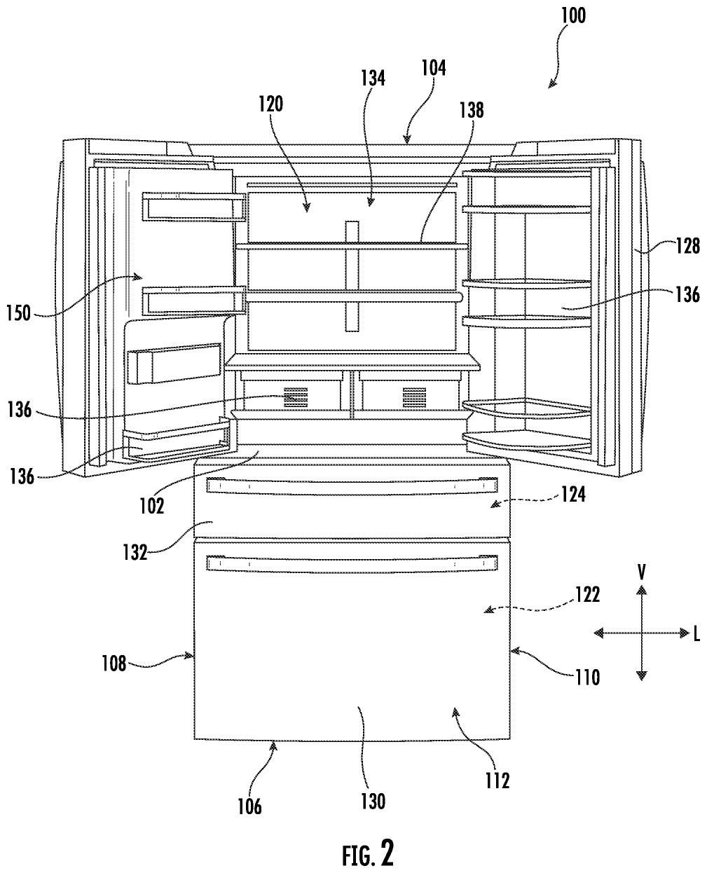

Referring now to the figures, an exemplary appliance will be described in accordance with exemplary aspects of the present subject matter. Specifically, FIG. 1 provides a perspective view of an exemplary refrigerator appliance 100 and FIG. 2 illustrates refrigerator appliance 100 with some of the doors in the open position. As illustrated, refrigerator appliance 100 generally defines a vertical direction V, a lateral direction L, and a transverse direction T, each of which is mutually perpendicular, such that an orthogonal coordinate system is generally defined.

According to exemplary embodiments, refrigerator appliance 100 includes a cabinet 102 that is generally configured for containing and/or supporting various components of refrigerator appliance 100 and which may also define one or more internal chambers or compartments of refrigerator appliance 100. In this regard, as used herein, the terms “cabinet,” “housing,” and the like are generally intended to refer to an outer frame or support structure for refrigerator appliance 100, e.g., including any suitable number, type, and configuration of support structures formed from any suitable materials, such as a system of elongated support members, a plurality of interconnected panels, or some combination thereof. It should be appreciated that cabinet 102 does not necessarily require an enclosure and may simply include open structure supporting various elements of refrigerator appliance 100. By contrast, cabinet 102 may enclose some or all portions of an interior of cabinet 102. It should be appreciated that cabinet 102 may have any suitable size, shape, and configuration while remaining within the scope of the present subject matter.

As illustrated, cabinet 102 generally extends between a top 104 and a bottom 106 along the vertical direction V, between a first side 108 (e.g., the left side when viewed from the front as in FIG. 1) and a second side 110 (e.g., the right side when viewed from the front as in FIG. 1) along the lateral direction L, and between a front 112 and a rear 114 along the transverse direction T. In general, terms such as “left,” “right,” “front,” “rear,” “top,” or “bottom” are used with reference to the perspective of a user accessing appliance 102.

Housing 102 defines chilled chambers for receipt of food items for storage. In particular, housing 102 defines fresh food chamber 120 positioned at or adjacent top 104 of housing 102, a freezer chamber 122 arranged at or adjacent bottom 106 of housing 102, and a convertible chamber 124 positioned between fresh food chamber 120 and freezer chamber 122 along the vertical direction. As such, refrigerator appliance 100 is generally referred to as a bottom mount refrigerator. It is recognized, however, that the benefits of the present disclosure apply to other types and styles of refrigerator appliances such as, e.g., a top mount refrigerator appliance, a side-by-side style refrigerator appliance, or a single door refrigerator appliance. Moreover, aspects of the present subject matter may be applied to other appliances as well. Consequently, the description set forth herein is for illustrative purposes only and is not intended to be limiting in any aspect to any particular appliance or configuration.

Refrigerator doors 128 are rotatably hinged to an edge of housing 102 for selectively accessing fresh food chamber 120. In addition, a freezer door 130 and a convertible compartment door 132 are arranged below refrigerator doors 128 for selectively accessing freezer chamber 122 and convertible chamber 124, respectively. Specifically, freezer door 130 and convertible compartment door 132 are coupled to drawer assemblies (not shown) that are slidably mounted within cabinet 102 via one or more slide assemblies. In general, refrigerator doors 128 form a seal over a front opening 134 defined by cabinet 102 (e.g., extending within a plane defined by the vertical direction V and the lateral direction L). In this regard, a user may place items within fresh food chamber 120 through front opening 134 when refrigerator doors 128 are open and may then close refrigerator doors 128 to facilitate climate control. Refrigerator doors 128, freezer door 130, and convertible compartment door 132 are shown in the closed configuration in FIG. 1. One skilled in the art will appreciate that other chamber and door configurations are possible and within the scope of the present invention.

FIG. 2 provides a perspective view of refrigerator appliance 100 shown with refrigerator doors 128 in the open position. As shown in FIG. 2, various storage components are mounted within fresh food chamber 120 to facilitate storage of food items therein as will be understood by those skilled in the art. In particular, the storage components may include bins 136 and shelves 138. Each of these storage components are configured for receipt of food items (e.g., beverages and/or solid food items) and may assist with organizing such food items. As illustrated, bins 136 may be mounted on refrigerator doors 128 or may slide into a receiving space in fresh food chamber 120. It should be appreciated that the illustrated storage components are used only for the purpose of explanation and that other storage components may be used and may have different sizes, shapes, and configurations.

Referring again to FIG. 1, a dispensing assembly 140 will be described according to exemplary embodiments of the present subject matter. Although several different exemplary embodiments of dispensing assembly 140 will be illustrated and described, similar reference numerals may be used to refer to similar components and features. Dispensing assembly 140 is generally configured for dispensing liquid water and/or ice. Although an exemplary dispensing assembly 140 is illustrated and described herein, it should be appreciated that variations and modifications may be made to dispensing assembly 140 while remaining within the present subject matter.

Dispensing assembly 140 and its various components may be positioned at least in part within a dispenser recess 142 defined on one of refrigerator doors 128. In this regard, dispenser recess 142 is defined on a front side 112 of refrigerator appliance 100 such that a user may operate dispensing assembly 140 without opening refrigerator door 128. In addition, dispenser recess 142 is positioned at a predetermined elevation convenient for a user to access ice and enabling the user to access ice without the need to bend-over. In the exemplary embodiment, dispenser recess 142 is positioned at a level that approximates the chest level of a user.

Dispensing assembly 140 includes an ice dispenser 144 including a discharging outlet 146 for discharging ice from dispensing assembly 140. An actuating mechanism 148, shown as a paddle, is mounted below discharging outlet 146 for operating ice or water dispenser 144. In alternative exemplary embodiments, any suitable actuating mechanism may be used to operate ice dispenser 144. For example, ice dispenser 144 can include a sensor (such as an ultrasonic sensor) or a button rather than the paddle. Discharging outlet 146 and actuating mechanism 148 are an external part of ice dispenser 144 and are mounted in dispenser recess 142. By contrast, refrigerator door 128 may define an icebox compartment 150 (FIG. 2) housing an icemaker and an ice storage bin (not shown) that are configured to supply ice to dispenser recess 142.

A control panel 152 is provided for controlling the mode of operation. For example, control panel 152 includes one or more selector inputs 154, such as knobs, buttons, touchscreen interfaces, etc., such as a water dispensing button and an ice-dispensing button, for selecting a desired mode of operation such as crushed or non-crushed ice. In addition, inputs 154 may be used to specify a fill volume or method of operating dispensing assembly 140. In this regard, inputs 154 may be in communication with a processing device or controller 156. Signals generated in controller 156 operate refrigerator appliance 100 and dispensing assembly 140 in response to selector inputs 154. Additionally, a display 158, such as an indicator light or a screen, may be provided on control panel 152. Display 158 may be in communication with controller 156, and may display information in response to signals from controller 156.

As used herein, “processing device” or “controller” may refer to one or more microprocessors or semiconductor devices and is not restricted necessarily to a single element. The processing device can be programmed to operate refrigerator appliance 100, dispensing assembly 140 and other components of refrigerator appliance 100. The processing device may include, or be associated with, one or more memory elements (e.g., non-transitory storage media). In some such embodiments, the memory elements include electrically erasable, programmable read only memory (EEPROM). Generally, the memory elements can store information accessible by a processing device, including instructions that can be executed by processing device. Optionally, the instructions can be software or any set of instructions and/or data that when executed by the processing device, cause the processing device to perform operations.

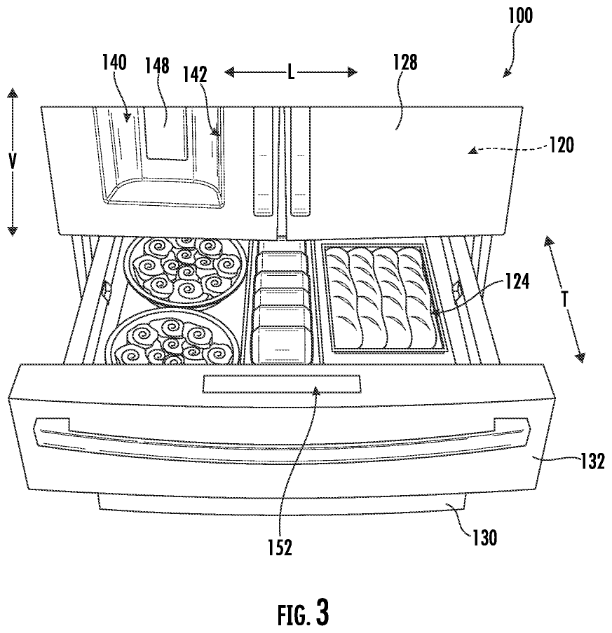

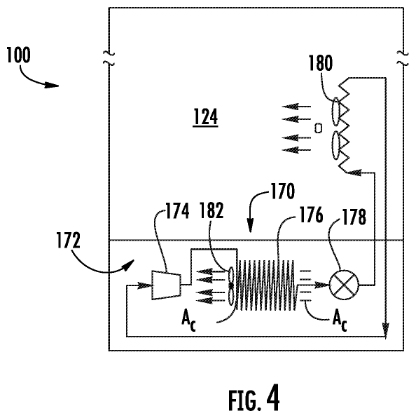

Referring now briefly to FIG. 4, a climate control assembly 170 of refrigerator appliance 100 will be described according to exemplary embodiments of the present subject matter. As explained above and illustrated in FIGS. 1 through 3, refrigerator appliance 100 is an upright refrigerator having a casing or cabinet 102 that defines a number of internal chilled storage compartments. FIG. 4 illustrates climate control assembly 170 as being configured for regulating the climate within a single chamber, i.e., convertible chamber 124. However, it should be appreciated that climate control assembly 170 may independently regulate each chamber of refrigerator appliance 100, e.g., through the use of multiple evaporators, internal ducting systems, dampers, etc. Accordingly, the climate control assembly 170 described herein is only exemplary and is not intended to limit the scope of the present subject matter in any manner.

FIG. 4 is a schematic view of certain components of refrigerator appliance 100, including a climate control assembly 170 of refrigerator appliance 100. For example, a machinery compartment 172 contains components for executing a known vapor compression cycle for cooling air. The components generally operate as a sealed refrigeration system and include a compressor 174, a condenser 176, an expansion device 178, and an evaporator 180 connected in series and charged with a refrigerant. As will be understood by those skilled in the art, the climate control assembly 170 may include additional components, e.g., at least one additional evaporator, compressor, expansion device, and/or condenser. In addition, climate control assembly 170 may further be operable to regulate the humidity within one or more chambers of refrigerator appliance 100.

During operation of the sealed refrigeration system of climate control assembly 170, refrigerant flows into compressor 174, which operates to increase the pressure of the refrigerant. This compression of the refrigerant raises its temperature, which is lowered by passing the refrigerant through condenser 176. Within condenser 176, heat exchange with ambient air takes place so as to cool the refrigerant. A fan 182 is used to pull air across condenser 176, as illustrated by arrows A_{C}, so as to provide forced convection for a more rapid and efficient heat exchange between the refrigerant within condenser 176 and the ambient air. Thus, as will be understood by those skilled in the art, increasing air flow across condenser 176 can, e.g., increase the efficiency of condenser 176 by improving cooling of the refrigerant contained therein.

An expansion device 178 (e.g., a valve, capillary tube, electronic expansion valve, or other restriction device) receives refrigerant from condenser 176. From expansion device 178, the refrigerant enters evaporator 180. Upon exiting expansion device 178 and entering evaporator 180, the refrigerant drops in pressure. Due to the pressure drop and/or phase change of the refrigerant, evaporator 180 is cool relative to convertible chamber 124 of refrigerator appliance 100. As such, cooled air is produced and refrigerates convertible chamber 124 of refrigerator appliance 100. Thus, evaporator 180 is a type of heat exchanger which transfers heat from air passing over evaporator 180 to refrigerant flowing through evaporator 180.

Collectively, the vapor compression cycle components in a refrigeration circuit, associated fans, and associated compartments are sometimes referred to as a sealed refrigeration system operable to force cold air through one or more compartments of an appliance. The sealed refrigeration system depicted in FIG. 4 is provided by way of example only. Thus, it is within the scope of the present subject matter for other configurations of the refrigeration system to be used as well. Furthermore, it should be appreciated that terms such as “refrigerant,” “gas,” “fluid,” and the like are generally intended to refer to a motive fluid for facilitating the operation of the sealed refrigeration system or climate control assembly 170, and may include, fluid, liquid, gas, or any combination thereof in any state.

Referring still to FIG. 1, a schematic diagram of an external communication system 190 will be described according to an exemplary embodiment of the present subject matter. In general, external communication system 190 is configured for permitting interaction, data transfer, and other communications between refrigerator appliance 100 and one or more external devices. For example, this communication may be used to provide and receive operating parameters, user instructions or notifications, performance characteristics, user preferences, or any other suitable information for improved performance of refrigerator appliance 100. In addition, it should be appreciated that external communication system 190 may be used to transfer data or other information to improve performance of one or more external devices or appliances and/or improve user interaction with such devices.

For example, external communication system 190 permits controller 156 of refrigerator appliance 100 to communicate with a separate device external to refrigerator appliance 100, referred to generally herein as an external device 192. As described in more detail below, these communications may be facilitated using a wired or wireless connection, such as via a network 194. In general, external device 192 may be any suitable device separate from refrigerator appliance 100 that is configured to provide and/or receive communications, information, data, or commands from a user. In this regard, external device 192 may be, for example, a personal phone, a smartphone, a tablet, a laptop or personal computer, a wearable device, a smart home system, or another mobile or remote device.

In addition, a remote server 196 may be in communication with refrigerator appliance 100 and/or external device 192 through network 194. In this regard, for example, remote server 196 may be a cloud-based server 196, and is thus located at a distant location, such as in a separate state, country, etc. According to an exemplary embodiment, external device 192 may communicate with a remote server 196 over network 194, such as the Internet, to transmit/receive data or information, provide user inputs, receive user notifications or instructions, interact with or control refrigerator appliance 100, etc. In addition, external device 192 and remote server 196 may communicate with refrigerator appliance 100 to communicate similar information.

In general, communication between refrigerator appliance 100, external device 192, remote server 196, and/or other user devices or appliances may be carried using any type of wired or wireless connection and using any suitable type of communication network, non-limiting examples of which are provided below. For example, external device 192 may be in direct or indirect communication with refrigerator appliance 100 through any suitable wired or wireless communication connections or interfaces, such as network 194. For example, network 194 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 190 is described herein according to an exemplary embodiment of the present subject matter. However, it should be appreciated that the exemplary functions and configurations of external communication system 190 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

Now that the construction and configuration of refrigerator appliance 100 and climate control assembly 170 have been presented according to an exemplary embodiment of the present subject matter, an exemplary method 200 for operating a climate control assembly 170 is provided. Method 200 can be used to operate climate control assembly 170, or to operate any other climate control assembly or sealed system for controlling the environment within a chilled chamber. In this regard, for example, controller 156 may be configured for implementing method 200. However, it should be appreciated that the exemplary method 200 is discussed herein only to describe exemplary aspects of the present subject matter and is not intended to be limiting.

As explained briefly above, yeast doughs require time to ferment and proof before baking, and that proofing time depends on a variety of factors, such as dough type (e.g., lean, enriched, sourdough, etc.), yeast type (e.g., active dry, instant, fresh, etc.), proofing temperature, etc. For example, a 40° F. yeast dough may not rise at all, while a 70° F. yeast dough may rise in approximately 2 hours. Home bakers will often prepare yeast doughs ahead of the baking time for a variety of reasons. This can require the baker to move dough to different locations to control the fermentation/proofing rate. For example, a baker may prepare a dough and proof it at room temperature for 2 hours then move it to the refrigerator to retard the proofing process. Alternatively, a baker may retard the dough in the refrigerator for several hours, even overnight, then remove it from the refrigerator 1-3 hours before baking to allow it to proof just before baking. This is common for foods such as cinnamon rolls where a baker may desire fresh baked cinnamon rolls in the morning but may prepare them the night before to avoid having to get up very early. Proofing the dough in the refrigerator overnight prevents the dough from over-proofing and allows the food to be kept safely overnight; however, this can be inconvenient because for the best quality the dough should be allowed to proof at room temperature for 1-3 hours before baking, such that the baker is still required to get an earlier start than may be desired. Accordingly, aspects of the present subject matter are directed to proofing compartments in refrigerator appliances and methods of operating the same to conveniently and effectively proof yeasted doughs and regulate the fermentation process.

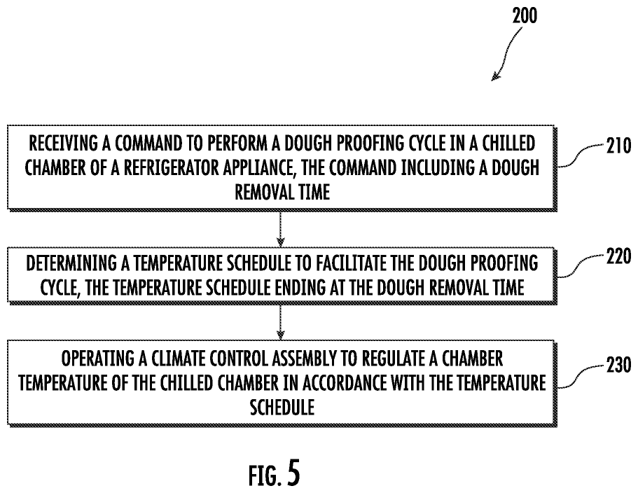

As shown in FIG. 5, method 200 includes, at step 210, receiving a command to perform a proofing cycle in a chilled chamber of a refrigerator appliance. In this regard, a user may wish to proof dough in convertible chamber 124 of refrigerator appliance 100 prior to baking. Accordingly, the user may input various information related to the proofing cycle or information that refrigerator appliance 100 may use to determine the desirable proofing conditions of the proofing cycle. It should be appreciated that the step of receiving a command to perform the dough proofing cycle may be received in any suitable manner. For example, according to an exemplary embodiment, a user interface panel, such as control panel 152, may be manipulated by a user to input the dough proofing cycle parameters and to issue the cycle initiation command. By contrast, according to alternative embodiments, the user may input such parameters and commands through a remote device, such as external device 192 (e.g., such as a cell phone, tablet, etc.).

In general, the command to perform the dough proofing cycle may include a dough removal time. In general, the dough removal time is generally intended to refer to the time that the dough proofing process should be completed for the next stage in the baking process. In this regard, for example, the dough removal time may correspond to a bake start time, e.g., or a time when a user wishes to initiate the baking process on the fully proofed dough. For example, if a user wishes to have freshly baked cinnamon rolls at 8:00 AM, the dough removal time may be approximately 7:30 AM (e.g., to permit a 30 minute baking process). Thus, at this time the cinnamon roll dough should be properly and fully proofed, but not under-proofed for over-proofed.

According to other exemplary embodiments, the dough removal time may correspond to another step in the baking process, such as the time which the dough needs to be manipulated. For example, for certain baking process, it may be desirable to manipulate or form the dough before it has been fully proofed (e.g., at a specific stage of proofing). Accordingly, the dough removal time may correspond to a dough manipulation time when such dough formation needs to be performed. In this regard, the raw dough to form cinnamon rolls may be mixed in the evening around 7:00 PM and it may be desirable to partially proof the dough (e.g., for about one hour) before forming into the cinnamon rolls. Accordingly, the dough removal time for the dough proofing cycle may be 8:00 PM. After the dough manipulation is complete, the user may replace the partially proofed dough back into the proofing compartment and may initiate another proofing cycle to complete the proofing process by 8:00 AM the following morning.

According to exemplary embodiments of the present subject matter, method 200 may include, in addition to obtaining the dough removal time, obtaining various proofing conditions associated with the dough proofing cycle. In this regard, when a user inputs a command to initiate the dough proofing cycle and provides a dough removal time, controller 156 may use display 158 (e.g., or external device 192) to prompt the user with questions to facilitate determination of the proper proofing conditions for the dough, such as proofing temperature. For example, the proofing conditions that are input by the user may include a dough type, a yeast type, a target proofing temperature, target proofing rate, and/or any other suitable proofing conditions which affect the proofing or fermentation process associated with the dough. It should be appreciated that controller 156 may be preprogrammed with proofing data tables that facilitate determination of the proper proofing cycle parameters based on the proofing conditions provided by the user.

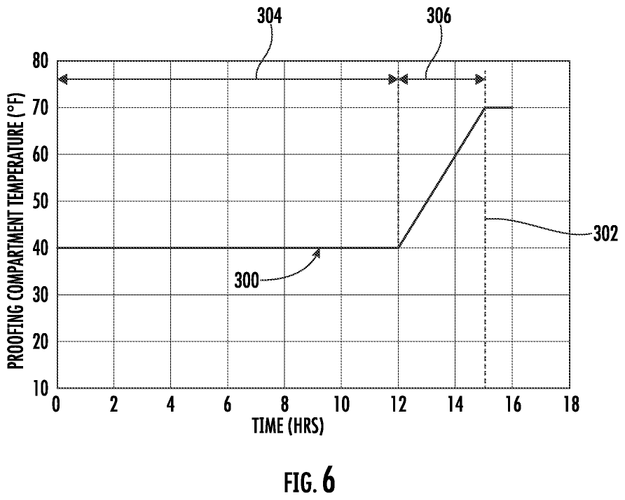

Referring again to FIG. 5, step 220 may include determining a temperature scheduled to facilitate the dough proofing cycle. In this regard, the temperature schedule generally refers to the desirable temperature of convertible chamber 124 during the time period extending from the initiation of the dough proofing cycle (e.g., when the command is received at step 210) and the dough removal time. Referring now briefly to FIG. 6, an exemplary proofing compartment temperature schedule 300 is illustrated. According to exemplary embodiments, controller 156 of refrigerator appliance 100 may be configured to generate such a temperature schedule 300 based at least in part on the inputs received by the user and one or more internal tables or databases.

For example, as illustrated, the temperature schedule 300 may commence at a time of zero hours (e.g., t=0) when a user finishes mixing a yeasted dough. At step 210, the user may initiate a dough proofing cycle that is intended to end at the dough removal time indicated generally by reference numeral 302. Accordingly, according to this example, the total time between preparing the dough and baking the dough is 16 hours. For example, a user may prepare dough for cinnamon rolls at 4:00 PM on one day and wish to bake those cinnamon rolls at 8:00 AM on the following day. Method 200 may include establishing temperature schedule 300 to properly proof the dough such that it is ready for baking at the dough removal time 302.

Notably, the temperature schedule may generally include a period of slow fermentation or slow fermentation (e.g., identified generally by reference numeral 304) followed by a fermentation/proofing period (e.g., identified generally by reference numeral 306) where the dough proofing is regulated at the desired rates (or these periods may be swapped). In this regard, for the first 12 hours after the dough was formed (i.e., during the slow fermentation period 304), climate control assembly 170 may maintain convertible chamber 124 at approximately 40° F. or any other suitably low temperature that retards the proofing process. At 12 hours, the fermentation/proofing period 306 may commence and the temperature of convertible chamber 124 may be slowly raised to facilitate dough proofing at desirable rates to achieve properly proofed dough at the removal time 302. More specifically, as illustrated, fermentation/proofing period 306 includes slowly ramping the temperature up from 40° F. to 70° F. to facilitate the proofing process.

As shown in FIG. 6, the temperature schedule 300 is split into fermentation versus slow fermentation periods. Thus, the dough was initially maintained at a lower predetermined temperature before the temperature is raised to a higher predetermined temperature to expedite the proofing process. However, it should be appreciated that according to alternative embodiments, the proofing rate may be regulated by controlling the temperature such that the proofing rate is constant for a total proofing time (e.g., the time between mixing the dough and the dough removal time). In this regard, determining the temperature schedule may include determining a total proofing time and obtaining a single proofing temperature that is executed for the entire proofing time. For example, this proofing temperature may be obtained from a lookup table and is typically inversely proportional or inversely related to the total proofing time. In this regard, for example, if a user wishes to proof dough over the total proofing time of one hour, the proofing temperature may be 80° F., whereas a total proofing time of six hours may merit a proofing temperature of 55° F.

Step 230 may generally include operating a climate control assembly to regulate a chamber temperature of the chilled chamber in accordance with the temperature schedule. In this regard, step 230 may include using climate control assembly 170 to regulate a chamber temperature within convertible chamber 124 to facilitate or perform the dough proofing cycle. Although step 230 is described herein as being used to regulate a chamber temperature, it should be appreciated that the humidity is within the chamber may also have an effect on the dough proofing process. Accordingly, climate control assembly 170 may be further configured for regulating chamber humidity in accordance with a humidity schedule. For example, humidity schedule may be determined in a similar manner as described above the temperature schedule at step 220.

FIG. 5 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of method 200 are explained using refrigerator appliance 100 as an example, it should be appreciated that this method may be applied to the operation of any suitable refrigerator appliance or any other appliance.

As explained above, aspects of the present subject matter are directed to a proofing compartment in a residential refrigerator appliance and methods of operating the same. The refrigerator appliance may independently control the temperature within the proofing compartment to regulate the fermentation/proofing process of dough more conveniently and with better quality. Custom temperature profiles can be executed within the proofing compartment to control the fermentation and proofing rate of dough based on a user inputting the time they plan to bake the product. This process helps the user by automatically determining appropriate proofing temperatures for them and offers convenience by adjusting proofing conditions to prepare the dough inline with the time that the user plans to carry out the next step such as baking the dough.

The custom proofing cycle can set a temperature to first retard, stop, or slow down the dough fermentation or proofing. Then, when appropriate, the custom proofing cycle may raise the proofing compartment temperature to allow the dough to rise properly before baking (or to facilitate some other baking step, e.g., shaping the dough). The dough can then be baked directly upon removing from the proofing compartment. A single temperature could also be set that allows controlled fermentation and/or slow rising of the dough over the period of time.

Accordingly, the temperature of a refrigerator proofing compartment can be automatically adjusted to provide the proper retarding and proofing temperatures without the baker needing to interact with the dough or manually adjust the drawer temperature. This process helps a baker to achieve proper proofing without needing to know what the proofing temperatures and durations are ideal by automatically controlling the proofing temperature. In addition, this process eliminates the necessity to take the dough out of the refrigerator at a specific time in order to permit room temperature fermentation.

According to exemplary embodiments, a custom proofing cycle may be programmed or selected to set a specific temperature during primary fermentation, e.g., in order to control the flavor profile of the dough. In this regard, a dough fermented at 40° F. vs 50° F. would have different flavor profiles (regardless of the temperature during the second fermentation/proofing stage). Other adjustments to the custom proofing cycle may be made while remaining within the scope of the present subject matter, e.g., such as adjustments to the proofing stage.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A refrigerator appliance comprising:
a cabinet defining a chilled chamber;
a door being movable between an open position and a closed position to provide selective access to the chilled chamber;
a climate control assembly for regulating a chamber temperature within the chilled chamber; and
a controller operably coupled to the climate control assembly, the controller being configured to:
receive a command to perform a dough proofing cycle and a dough removal time;
determine a temperature schedule to facilitate the dough proofing cycle, the temperature schedule ending at the dough removal time; and
operate the climate control assembly to regulate a chamber temperature of the chilled chamber in accordance with the temperature schedule.

2. The refrigerator appliance of claim 1, wherein the controller is further configured to:
obtain proofing conditions associated with the dough proofing cycle, wherein the temperature schedule is determined based at least in part on the proofing conditions.

3. The refrigerator appliance of claim 2, wherein the proofing conditions comprise at least one of a dough type, a yeast type, a target proofing temperature, or a target proofing rate.

4. The refrigerator appliance of claim 2, further comprising:
a user interface panel, wherein the command to perform the dough proofing cycle is provided through the user interface panel.

5. The refrigerator appliance of claim 2, wherein the controller is in operative communication with a remote device through an external network, and wherein the command to perform the dough proofing cycle is provided through the remote device.

6. The refrigerator appliance of claim 1, wherein determining the temperature schedule to facilitate the dough proofing cycle comprises:
determining a slow fermentation period and a fermentation/proofing period leading up to the dough removal time; and
determining a proof retarding temperature for use during the slow fermentation period and a proofing temperature for use during the fermentation/proofing period.

7. The refrigerator appliance of claim 6, wherein the proof retarding temperature is a lower predetermined temperature for minimizing fermentation and the proofing temperature is a higher predetermined temperature for achieving a target fermentation rate.

8. The refrigerator appliance of claim 1, wherein determining the temperature schedule to facilitate the dough proofing cycle comprises:
determining a total proofing time between receipt of the command to perform the dough proofing cycle and the dough removal time; and
obtaining a proofing temperature for the total proofing time.

9. The refrigerator appliance of claim 8, where the proofing temperature is obtained from a lookup table.

10. The refrigerator appliance of claim 8, where the proofing temperature is inversely related to the total proofing time.

11. The refrigerator appliance of claim 1, wherein the dough removal time corresponds to a bake start time for initiating a baking process.

12. The refrigerator appliance of claim 1, wherein the dough removal time corresponds to a dough manipulation time.

13. The refrigerator appliance of claim 1, wherein the climate control assembly is configured for regulating a chamber humidity within the chilled chamber, and wherein the controller is further configured to:
determine a humidity schedule to facilitate the dough proofing cycle, the humidity schedule ending at the dough removal time; and
operate the climate control assembly to regulate a chamber humidity of the chilled chamber in accordance with the humidity schedule.

14. A method of proofing dough in a refrigerator appliance, the refrigerator appliance comprising a chilled chamber and a climate control assembly for regulating a chamber temperature within the chilled chamber, the method comprising:
receiving a command to perform a dough proofing cycle and a dough removal time;
determining a temperature schedule to facilitate the dough proofing cycle, the temperature schedule ending at the dough removal time; and
operating the climate control assembly to regulate a chamber temperature of the chilled chamber in accordance with the temperature schedule.

15. The method of claim 14, further comprising:
obtaining proofing conditions associated with the dough proofing cycle, wherein the temperature schedule is determined based at least in part on the proofing conditions.

16. The method of claim 15, wherein the proofing conditions comprise at least one of a dough type, a yeast type, a target proofing temperature, or a target proofing rate.

17. The method of claim 14, wherein determining the temperature schedule to facilitate the dough proofing cycle comprises:
determining a slow fermentation period and a fermentation/proofing period leading up to the dough removal time; and
determining a proof retarding temperature for use during the slow fermentation period and a proofing temperature for use during the fermentation/proofing period.

18. The method of claim 17, wherein the proof retarding temperature is a lower predetermined temperature for minimizing fermentation and the proofing temperature is a higher predetermined temperature for achieving a target fermentation rate.

19. The method of claim 14, wherein determining the temperature schedule to facilitate the dough proofing cycle comprises:
determining a total proofing time between receipt of the command to perform the dough proofing cycle and the dough removal time; and
obtaining a proofing temperature for the total proofing time.

20. The method of claim 19, where the proofing temperature is obtained from a lookup table and is inversely related to the total proofing time.
